(19) United States
(12) Patent Application Publication
(10) Pub. No.: US 2020/0047686 A1
(43) Pub. Date: Feb. 13, 2020

(54) DISPLAY DEVICE, DISPLAY CONTROL METHOD, AND STORAGE MEDIUM

(71) Applicant: HONDA MOTOR CO., LTD., Tokyo (JP)

(72) Inventors: Masafumi Higashiyama, Wako-shi (JP); Takuya Kimura, Wako-shi (JP); Shinji Kawakami, Wako-shi (JP); Tatsuya Iwasa, Wako-shi (JP); Yuji Kuwashima, Wako-shi (JP)

(21) Appl. No.: 16/529,832

(22) Filed: Aug. 2, 2019

(30) Foreign Application Priority Data
Aug. 7, 2018 (JP) 2018-148550

(51) Int. Cl. B60R 11/02; B60R 11/04

(52) U.S. Cl. CPC B60R 11/0235; B60R 2011/0026; B60R 11/04

(57) ABSTRACT

A display device mounted on a vehicle includes an image generation device configured to project image light that is light including an image toward a projection area on a front windshield, a target information acquirer configured to acquire at least a position of a target present around the vehicle, and a controller configured to control the image generation device. The controller determines whether or not the target is in a space area of a destination passing through the projection area as viewed from an occupant of the vehicle, in a case in which the target is in the space area of the destination passing through the projection area as viewed from the occupant of the vehicle, the controller causes the image generation device to project the image light that appears to be superimposed on the position of the target, and in a case in which the target is not in the space area of the destination passing through the projection area as viewed from the occupant of the vehicle, the controller causes the image generation device to project the image light notifying of presence of the target in the projection area.

### CROSS-REFERENCE TO RELATED APPLICATION

Priority is claimed on Japanese Patent Application No. 2018-148550, filed Aug. 7, 2018, the content of which is incorporated herein by reference.

### BACKGROUND

### Field of the Invention

The present invention relates to a display device, a display control method, and a storage medium.

### Description of Related Art

In the related art, a head up display (HUD) device that displays an image related to basic information for a driver on a front windshield is known (refer to, for example, Japanese Unexamined Patent Application First Publication No. 2017-91115). Using this HUD device, various marks indicating an obstacle, a reminder, and a progress direction are displayed over a landscape in front of a vehicle, and thus a driver is able to ascertain various pieces of displayed information while maintaining a direction of a line of sight to the front at the time of driving.

### SUMMARY

Since a HUD device uses light reflection, the HUD device is able to display the image anywhere on a reflector even in a case in which the location of a light projector is not completely free. In the related art, the possibility of display in a limited area of a reflector and ways to incorporate expansion of the real world have not been sufficiently investigated.

An aspect of the present invention has been made in consideration of such circumstances and an object of the aspect of the present invention is to provide a display device, a display control method, and a storage medium capable of suitably covering the world outside an area of an augmented reality (AR) display.

A display device according to the present invention adopts the following constitutions.

(1): A display device according to an aspect of the present invention is mounted on a vehicle and includes an image generation device configured to project image light that is light including an image toward a projection area on a front windshield, a target information acquirer configured to acquire at least a position of a target present around the vehicle, and a controller configured to control the image generation device. The controller determines whether or not the target is in a space area of a destination passing through the projection area as viewed from an occupant of the vehicle, in a case in which the target is in the space area of the destination passing through the projection area as viewed from the occupant of the vehicle, the controller causes the image generation device to project the image light that appears to be superimposed on the position of the target, and in a case in which the target is not in the space area of the destination passing through the projection area as viewed from the occupant of the vehicle, the controller causes the image generation device to project the image light notifying of presence of the target in the projection area.

(2): In the aspect of (1) described above, the controller determines whether or not the target enters the space area within a predetermined time or within a predetermined traveling distance on the basis of a relative position change between the vehicle and the target, and in a case in which it is determined that the target enters the space area within the predetermined time or within the predetermined traveling distance, the controller causes the image generation device to project the image light notifying of the presence of the target in the projection area.

(3): In the aspect of (1) described above, the controller estimates a position where the target first appears in the projection area on the basis of a relative position change between the vehicle and the target, and controls the image generation device so that the image light notifying of the presence of the target is projected at the estimated position.

(4): In the aspect of (1) described above, the controller controls the image generation device to change a display mode of the image light notifying of the presence of the target on the basis of a time until the target enters the space area, which is calculated on the basis of a relative positional change between the vehicle and the target.

(5): In the aspect of (1) described above, the controller controls the image generation device to cause the image light notifying of the presence of the target a light to have a color close to an environmental color in comparison with the image light that appears to be superimposed on the position of the target.

(6): In the aspect of (1) described above, the image generation device includes a light projector configured to project the light including the image, an optical mechanism provided on a path of the light and capable of adjusting a distance from a predetermined position to a position where the light is formed as a virtual image, a concave mirror configured to reflect light passing through the optical mechanism toward a reflector, a first actuator configured to adjust the distance in the optical mechanism, and a second actuator configured to adjust a reflection angle of the concave mirror.

(7): A display control method according to another aspect of the present invention causes a controller of a display device, which is mounted in a vehicle and comprises an image generation device configured to project image light that is light including an image toward a projection area on a front windshield and a target information acquirer configured to acquire at least a position of a target present around the vehicle, to determine whether or not the target is in a space area of a destination passing through the projection area as viewed from an occupant of the vehicle, cause the image generation device to project the image light that appears to be superimposed on the position of the target in a case in which the target is in the space area of the destination passing through the projection area as viewed from the occupant of the vehicle, and cause the image generation device to project the image light notifying of presence of the target in the projection area in a case in which the target is not in the space area of the destination passing through the projection area as viewed from the occupant of the vehicle.

(8): A non-transitory computer-readable storage medium according to still another aspect of the present invention stores a program that causes a controller of a display device, which is mounted in a vehicle and comprises an image generation device configured to project image light that is light including an image toward a projection area on a front windshield and a target information acquirer configured to acquire at least a position of a target present around the vehicle, to determine whether or not the target is in a space area of a destination passing through the projection area as viewed from an occupant of the vehicle, cause the image generation device to project the image light that appears to be superimposed on the position of the target in a case in which the target is in the space area of the destination passing through the projection area as viewed from the occupant of the vehicle, and cause the image generation device to project the image light notifying of presence of the target in the projection area in a case in which the target is not in the space area of the destination passing through the projection area as viewed from the occupant of the vehicle.

According to the aspects of (1) to (8), it is possible to suitably cover a world outside an area of AR display.

According to the aspect (2) described above, it is possible to suppress unnecessary display and allow an occupant not to feel troublesome.

According to the aspect (3) described above, it is possible to intuitively transfer the presence of the target to the occupant.

According to the aspect (4) described above, it is possible to intuitively transfer an approach state of the target to the occupant.

### BRIEF DESCRIPTION OF THE DRAWINGS

FIG. 1 is a diagram exemplifying a constitution of an interior of a vehicle on which a display device according to an embodiment is mounted.

FIG. 2 is a diagram for describing an operation switch of the embodiment.

FIG. 3 is a partial constitution diagram of the display device.

FIG. 4 is a diagram showing a constitution example of a display device centering on a display controller.

FIG. 5 is a diagram for describing a determination method of an area determiner.

FIG. 6 is a diagram showing an example of an AR image.

FIG. 7 is a diagram showing an example of a presence notification image.

FIG. 8 is a diagram showing an example of the presence notification image for a fixed target.

FIG. 9 is a diagram showing an example of the AR image for the fixed target.

FIG. 10 is a diagram showing an example of a change of the presence notification image.

FIG. 11 is a flowchart showing an example of a flow of a process performed by the display controller.

### DESCRIPTION OF EMBODIMENTS

Hereinafter, an embodiment of a display device, a display control method, and a storage medium of the present invention will be described with reference to the drawings. The display device is of an embodiment, for example, a device that is mounted on a vehicle (hereinafter referred to as a vehicle M) and causes an image to be visually recognized by being superimposed on a landscape. The display device is able to be referred to as a HUD device. As an example, a display device is a device that allows a viewer to visually recognize a virtual image by projecting light including an image on a front windshield of the vehicle M. The viewer is, for example, a driver, however, the viewer may be an occupant other than the driver.

In the following description, a positional relationship and the like will be described using an XYZ coordinate system as appropriate.

[Overall Constitution]

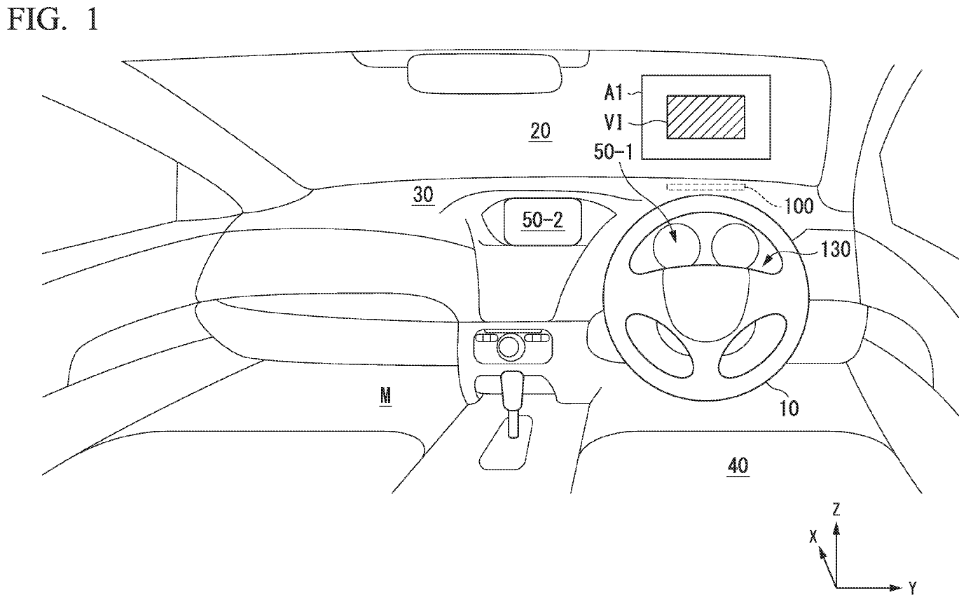

FIG. 1 is a diagram exemplifying a constitution of an interior of the vehicle M on which a display device 100 according to an embodiment is mounted. The vehicle M is provided with, for example, a steering wheel 10 that controls steering of the vehicle M, a front windshield 20 that divides the interior of the vehicle from the outside of the vehicle, and an instrument panel 30. The front windshield 20 is a member having light transparency. The display device 100 allows the driver sitting in a driver's seat to visually recognize a virtual image VI by, for example, projecting light including an image on a displayable area (projection area) A1 provided in a part of the front windshield 20 in front of a driver's seat 40.

The display device 100 causes the driver to visually recognize an image (hereinafter, driving support image) obtained by imaging, for example, information for supporting driving of the driver as a virtual image VI. The information for supporting the driving of the driver includes, for example, information of a speed of the vehicle M, a driving power distribution ratio, an engine speed, an operation state of a driving support function, a shift position, a sign recognition result, an intersection point position, and the like. The driving support function includes, for example, a direction indication function for guiding the vehicle M to a destination that is set in advance, an adaptive cruise control (ACC), a lane keep assist system (LKAS), a collision mitigation brake system (CMBS), a traffic jam assist function, and the like. The driving support function may include, for example, an incoming call or outgoing call of a telephone mounted on the vehicle M, and a telephone function for managing a call.

The display device 100 allows the driver to visually recognize an image (AR image or presence notification image) indicating the position of a target present around the vehicle M as a virtual image VI. The target is a target such as another vehicle, a bicycle, a pedestrian, and as an obstacle, a fixed target such as an intersection, or another entity.

In addition to the display device 100, the vehicle M may be provided with a first display unit 50-1 and a second display unit 50-2. The first display unit 50-1 is a display device provided, for example, in the vicinity of the front of the driver's seat 40 in the instrument panel 30 and is able to be visually recognized by the driver from a gap of the steering wheel 10 or is able to be visually recognized through the steering wheel 10. The second display unit 50-2 is attached to, for example, a central portion of the instrument panel 30. The second display unit 50-2 displays, for example, an image corresponding to a navigation process performed by a navigation device (not shown) mounted on the vehicle M, or a video of the other party in a videophone or the like. The second display unit 50-2 may display a television program, reproduce a DVD, or display contents such as a downloaded movie.

The vehicle M is provided with an operation switch 130 that receives an instruction to switch on/off the display by the display device 100 or an instruction to adjust a position of the virtual image VI. The operation switch 130 is attached, for example, to a position where the driver sitting on the driver's seat 40 is able to operate without greatly changing a posture. The operation switch 130 may be provided, for example, in front of the first display unit 50-1, may be provided on a boss portion of the steering wheel 10, or may be provided on a spoke that connects the steering wheel 10 and the instrument panel 30 with each other.

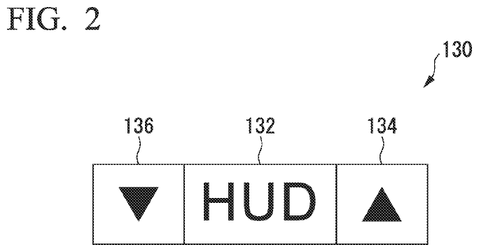

FIG. 2 is a diagram for describing the operation switch 130 of the embodiment. The operation switch 130 includes, for example, a main switch 132, and adjustment switches 134 and 136. The main switch 132 is a switch that switches on/off of the display device 100.

The adjustment switch 134 is, for example, a switch for receiving an instruction to move the position of the virtual image VI that is visually recognized as being in a space transmitted from a line of sight position P1 of the driver through the displayable area A1 to an upper side (hereinafter, referred to as an upward direction) with respect to a vertical direction Z. The driver is able to continuously move the visually recognized position of the virtual image VI in the upward direction in the displayable area A1 by continuously pressing the adjustment switch 134.

The adjustment switch 136 is a switch for receiving an instruction to move the position of the virtual image VI described above to a lower side (hereinafter, referred to as a downward direction) with respect to the vertical direction Z. The driver is able to continuously move the visually recognized position of the virtual image VI in the downward direction in the displayable area A1 by continuously pressing the adjustment switch 136.

The adjustment switch 134 may be a switch for increasing a brightness of the virtual image VI to be visually recognized instead of (or in addition to) moving the position of the virtual image VI in the upward direction. The adjustment switch 136 may be a switch for reducing the brightness of the virtual image VI to be visually recognized instead of (or in addition to) moving the position of the virtual image VI in the downward direction. Contents of the instruction received by the adjustment switches 134 and 136 may be switched on the basis of a certain operation. The certain operation is, for example, a long press operation of the main switch 132. In addition to the switches shown in FIG. 2, the operation switch 130 may include, for example, a switch for selecting display content or a switch for adjusting the brightness of the virtual image to be exclusively displayed.

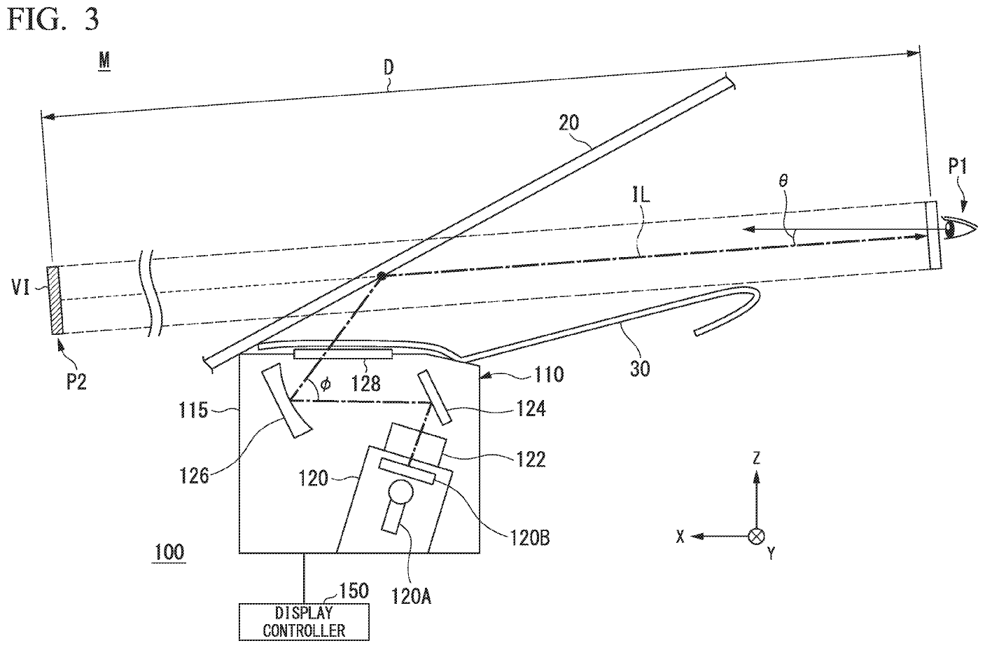

FIG. 3 is a partial constitution diagram of the display device 100. The display device 100 includes, for example, a display (an example of an image generation device) 110 and a display controller (an example of a controller) 150. The display 110 accommodates a light projector 120, an optical mechanism 122, a plane mirror 124, a concave mirror 126, and a light transmission cover 128, for example, in a housing 115. In addition to these, the display device 100 includes various sensors and actuators, which will be described later. The display may have a constitution without the optical mechanism 122.

The light projector 120 includes, for example, a light source 120A and a display element 120B. The light source 120A is, for example, a cold cathode tube, and outputs visible light corresponding to the virtual image VI to be visually recognized by the driver. The display element 120B controls transmission of the visible light from the light source 120A. The display element 120B is, for example, a liquid crystal display (LCD) of a thin film transistor (TFT) type. The display element 120B causes an image element to be included in the virtual image VI by controlling each of a plurality of pixels to control a transmission degree of the visible light from the light source 120A for each color element, and determines a form (look) of the virtual image VI. Hereinafter, the visible light transmitted through the display element 120B and including the image is referred to as image light IL. The display element 120B may be an organic EL (electro-luminescence) display, and in this case the light source 120A may be omitted.

The optical mechanism 122 includes, for example, one or more lenses. The position of each lens is able to be adjusted, for example, in an optical axis direction. The optical mechanism 122 is provided, for example, on a path of the image light IL output from the light projector 120, and passes the image light IL incident from the light projector 120 and emits the image light IL toward the front windshield 20. The optical mechanism 122 is able to adjust, for example, a distance (hereinafter referred to as a virtual image visual recognition distance D) from the line of sight position P1 of the driver to a formation position P2 where the image light IL is formed as the virtual image by changing the position of the lens. The line of sight position P1 of the driver is a position where the image light IL is collected by being reflected by the concave mirror 126 and the front windshield 20, and is a position where it is assumed that the eyes of the driver are present at this position. The virtual image visual recognition distance D is strictly a distance of a line segment having an inclination in the vertical direction, however, in the following description, in a case in which it is expressed that “the virtual image visual recognition distance D is 7 [m]” or the like, the distance may mean the distance in the horizontal direction.

In the following description, a depression angle θis defined as an angle formed by a horizontal plane passing through the line of sight position P1 of the driver and the line segment from the line of sight position P1 of the driver to the formation position P2. The more the virtual image VI is formed downward, that is, the more downward the line of sight direction at which the driver views the virtual image VI, the larger the depression angle θ. The depression angle θ is determined on the basis of a reflection angle φ of the concave mirror 126 and a display position of an original image on the display element 120B. The reflection angle φ is an angle formed by an incident direction in which the image light IL reflected by the plane mirror 124 enters the concave mirror 126 and an emission direction in which the concave mirror 126 emits the image light IL.

The plane mirror 124 reflects the visible light (that is, the image light IL) emitted by the light source 120A and having passed through the display element 120B in a direction of the concave mirror 126.

The concave mirror 126 reflects the image light IL incident from the plane mirror 124 and emits the image light IL toward the front windshield 20. The concave mirror 126 is supported so as to be rotatable (pivotable) about a Y axis that is an axis in a width direction of the vehicle M.

The light transmission cover 128 transmits the image light IL from the concave mirror 126 to cause the image light IL to reach the front windshield 20, and suppresses an entry of a foreign matter such as dust, dirt, or a water droplet into the housing 115. The light transmission cover 128 is provided in opening formed in an upper member of the housing 115. The instrument panel 30 is also provided with an opening or a light transmission member, and the image light IL passes through the light transmission cover 128 and the opening of the instrument panel 30 or the light transmission member to be reached the front windshield 20.

The image light IL incident to the front windshield 20 is reflected by the front windshield 20 and condensed at the line of sight position P1 of the driver. At this time, in a case in which the eye of the driver is positioned at the line of sight position P1 of the driver, the driver feels that the image captured by the image light IL is displayed in front of the vehicle M.

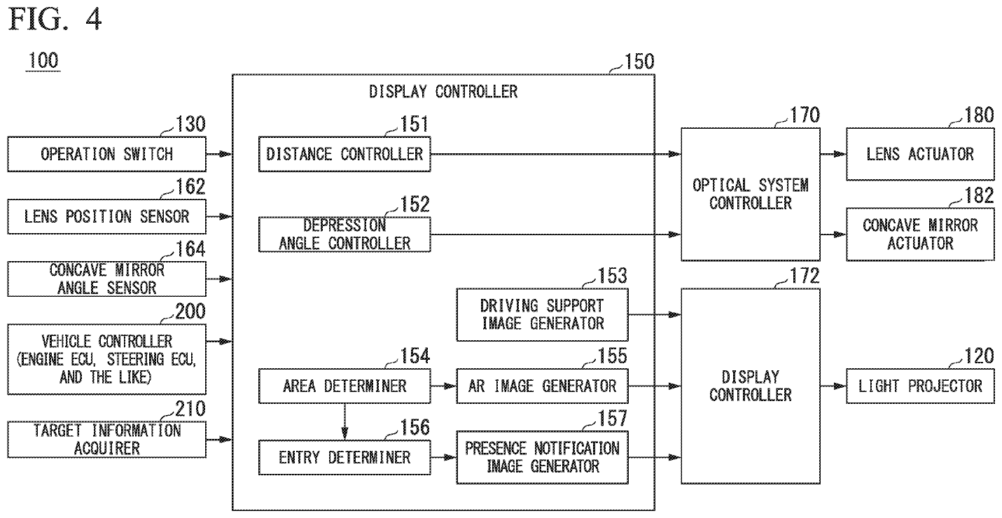

The display controller 150 controls the display of the virtual image VI to be visually recognized by the driver. FIG. 4 is a diagram showing a constitution example of the display device 100 centering on the display controller 150. In an example of FIG. 4, in addition to the display controller 150, a light projector 120, an operation switch 130, a lens position sensor 162, a concave mirror angle sensor 164, an optical system controller 170, a display controller 172, a lens actuator (an example of a first actuator) 180, a concave mirror actuator (an example of a second actuator) 182, a vehicle controller 200, and a target information acquirer 210 are shown. First, each constitution other than the display controller 150 will be described.

The lens position sensor 162 detects a position of one or more lenses included in the optical mechanism 122. The concave mirror angle sensor 164 detects a rotation angle of the concave mirror 126 about the Y axis.

The optical system controller 170 drives the lens actuator 180 on the basis of the control signal output by the display controller 150 to adjust the virtual image visual recognition distance D. The virtual image visual recognition distance D is able to be adjusted, for example, within a range of several [m] to dozen [m] (or several tens [m]). The optical system controller 170 drives the concave mirror actuator 182 on the basis of the control signal output by the display controller 150 to adjust the reflection angle φ of the concave mirror.

The display controller 172 causes the light projector 120 to project the light including the image on the basis of the signal supplied from the display controller 150.

The lens actuator 180 acquires a drive signal from the optical system controller 170, drives a motor or the like on the basis of the acquired drive signal, and moves the position of one or more lenses included in the optical mechanism 122. Therefore, the virtual image visual recognition distance D is adjusted.

The concave mirror actuator 182 acquires a drive signal from the optical system controller 170, drives a motor or the like on the basis of the acquired drive signal, and rotates the concave mirror actuator 182 about the Y axis to adjust the reflection angle φ of the concave mirror 126. Therefore, the depression angle θ is adjusted.

The vehicle controller 200 is an engine electronic controller (ECU) that controls a traveling drive device such as an engine or a motor, and a steering ECU that controls a steering device. As an example, the vehicle controller 200 outputs information such as the speed of the vehicle M, the engine speed, an operation state of a direction indicator, a steering angle, and a yaw angular velocity to the display controller 150.

For example, a target information acquirer 210 includes a part or all of a camera that images the front of the vehicle M, an image analysis device that analyzes the captured image, a radar device, light detection and ranging (LIDAR), an object recognition device that specifies a type of the target based on outputs of these devices or a driving support device that receives information of the target and performs driving support control. The target information acquirer 210 may acquire information of a fixed target using map information and a positioning device such as global positioning system (GPS). Furthermore, the target object information acquirer 210 may include a navigation device, and acquire information on a point where the vehicle M should turn left or right, branch, merge, etc. as the information of the fixed target. In the following description, it is assumed that the target information acquirer 210 specifies the type of the target, and outputs the information indicating the type, and a position and a relative velocity vector of the target to the display controller 150.

Hereinafter, the display controller 150 will be described. The display controller 150 includes, for example, a distance controller 151, a depression angle controller 152, a driving support image generator 153, an area determiner 154, an AR image generator 155, an entry determiner 156, and a presence notification image generator 157. Such constitution elements are realized, for example, by a hardware processor such as a central processing unit (CPU) executing a program (software). Some or all of such constitution elements may be realized by hardware (a circuit unit; including circuitry) such as a large scale integration (LSI), an application specific integrated circuit (ASIC), a field-programmable gate array (FPGA), and a graphics processing unit (GPU) or may be realized by software and hardware in cooperation. The program may be stored in advance in a storage device such as an HDD or a flash memory, stored in a removable storage medium such as a DVD or a CD-ROM, or may be installed by attachment of a storage medium to a drive device. The division of the constitution elements of the display controller 150 is merely for convenience, and does not mean that software and hardware are clearly separated as shown in the figure.

The distance controller 151 outputs the control signal for adjusting the virtual image visual recognition distance D to the optical system controller 170. For example, the distance controller 151 increases the virtual image visual recognition distance D as the speed of the vehicle M increases, and reduces the virtual image visual recognition distance D as the speed of the vehicle M decreases. This matches a tendency of the driver to view further ahead as the speed increases.

The depression angle controller 152 outputs the control signal for adjusting the reflection angle φ of the concave mirror 126 to the optical system controller 170. For example, the depression angle controller 152 adjusts the reflection angle φ on the basis of the operation on the operation switch 130. The depression angle controller 152 reduces the reflection angle φ and reduces the depression angle θ as the virtual image visual recognition distance D is increased.

The driving support image generator 153 generates a driving support image that is displayed relatively constantly and is not related to the target among the images (hereinafter referred to simply as an image) provided by the display device 100 as the virtual image VI and causes the light projector 120 to project image light through the display controller 172. The driving support image is an image that displays, for example, the speed of the vehicle M, the driving power distribution ratio, the engine speed, the operation state of the driving support function, the shift position, and the like.

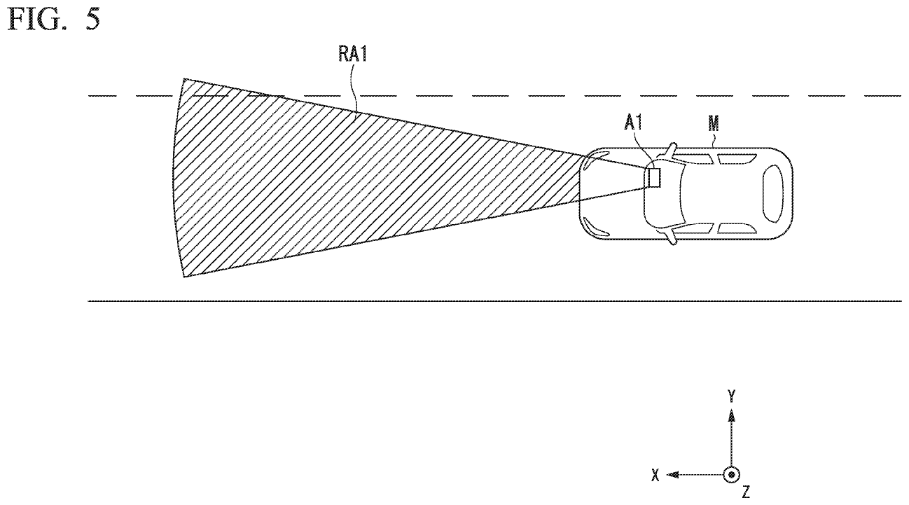

The area determiner 154 determines whether or not the target input from the target information acquirer 210 is in a space area of a destination passing through the displayable area A1 as viewed by the occupant (the driver in the example of the present embodiment) of the vehicle. FIG. 5 is a diagram for describing a determination method of the area determiner 154. In a case in which the target is on a road surface area RA1 obtained by projecting the space area onto a road surface, the area determiner 154 determines that the target is in the space area. Since the space area changes in accordance with the depression angle θ, the area determiner 154 reads the map of the road surface area RA1 according to the depression angle θ from the storage unit, and specifies the road surface area RA1 on the basis of the read map. In addition, in a case in which the position of the target input by the target information acquirer 210 falls within the road surface area RA1, the area determiner 154 determines that the target is in the space area.

In a case in which it is determined that the target is in the above-described space area, the AR image generator 155 causes the light projector 120 to project the image light that appears to be superimposed on the target to generate an image (AR image) that appears to be superimposed on the target.

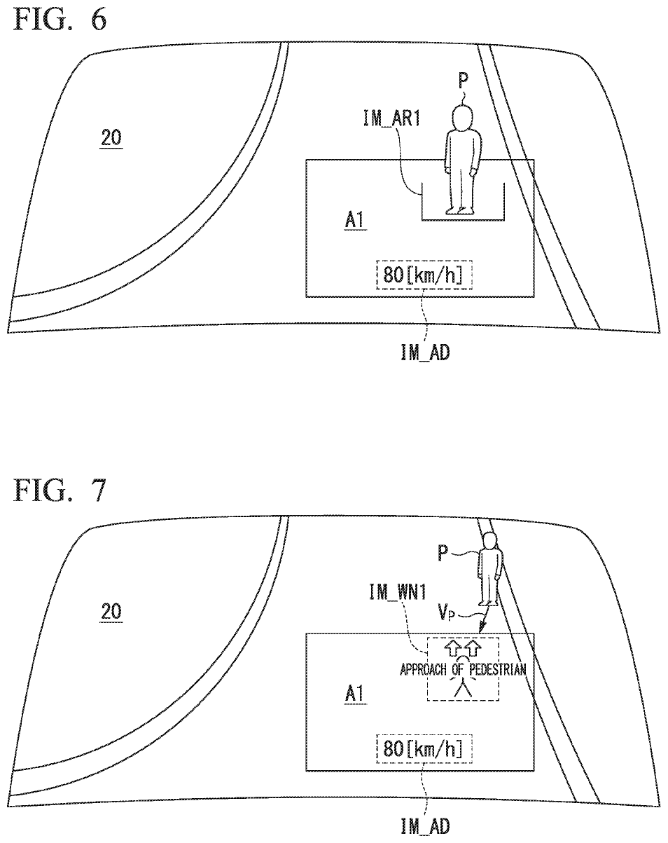

FIG. 6 is a diagram showing an example of the AR image.

In the shown example, it is determined that a pedestrian P crossing a road in front of the vehicle M is in the space area, and as a result, an AR image IM_AR1 that surrounds the pedestrian P is generated. “Generate” is a convenient expression, and may simply refer to an operation of reading image data from the storage device, outputting the image data to the display controller 172, and displaying the image data on the display 110. In the example of FIG. 6, a driving support image IM_AD is displayed together with the AR image IM_AR1.

The entry determiner 156 determines whether or not a target determined not to be in the space area by the area determiner 154 enters the space area within a predetermined time (or a predetermined distance related to a traveling distance of the vehicle M) on the basis of the position of the target and the relative velocity vector input from the target information acquirer 210. For example, the entry determiner 156 uses the map used by the area determiner 154, assumes that the target maintains a constant current relative velocity vector, and determines whether or not the position after the predetermined time is in the road surface area RA1. In a case in which the position after the predetermined time is in the road surface area RA1, the entry determiner 156 determines that “the target enters the space area within the predetermined time”. Instead of assuming that the relative velocity vector is constant, the above-described determination may be performed by assuming that acceleration or jerk is constant.

The presence notification image generator 157 causes the light projector 120 to project the image light notifying of the presence of the target to generate a presence notification image notifying of the presence of the target that is not in the space of the destination of the displayable area Al, for the target determined to enter the space area within the predetermined time by the entry determiner 156.

FIG. 7 is a diagram showing an example of the presence notification image. In the shown example, it is determined that the pedestrian P crossing the road in front of the vehicle M enters the space area within the predetermined time, and a presence notification image IM_WN1 notifying of an approach of the pedestrian P is generated. Here, the presence notification image generator 157 may calculate a position where the target first appears in the displayable area A1 in consideration of the relative velocity vector of the target, and display the presence notification image IM_WN1 in the vicinity of a location where the target first appear (a location where the target enters the displayable area A1 viewed by the driver). In the figure, V_{P} is a projection of the relative velocity vector of the pedestrian P relative to the vehicle M on the road surface. The presence notification image generator 157 obtains a point at which a line obtained by extending Vₚ obtained by projecting the relative velocity vector on the road surface intersects the road surface area RA1 on which the space area is projected on the road surface and projects (transforms) the point onto a plane of the front windshield from the road surface area to calculate the display location. In addition, an image is generated so that the presence notification image IM_WN1 is displayed at the calculated display location. Therefore, the display device 100 is able to intuitively transfer the approach and an approach direction of the target to the driver.

Since the presence notification image is less urgent than the AR image, it is preferable that the presence notification image be an image close to an environment color (ambient image) in comparison with the AR image. For example, the presence notification image generator 157 may analyze a captured image of an in-vehicle camera (not shown), extract a color component close to the environment color, and generate the presence notification image using the extracted color component.

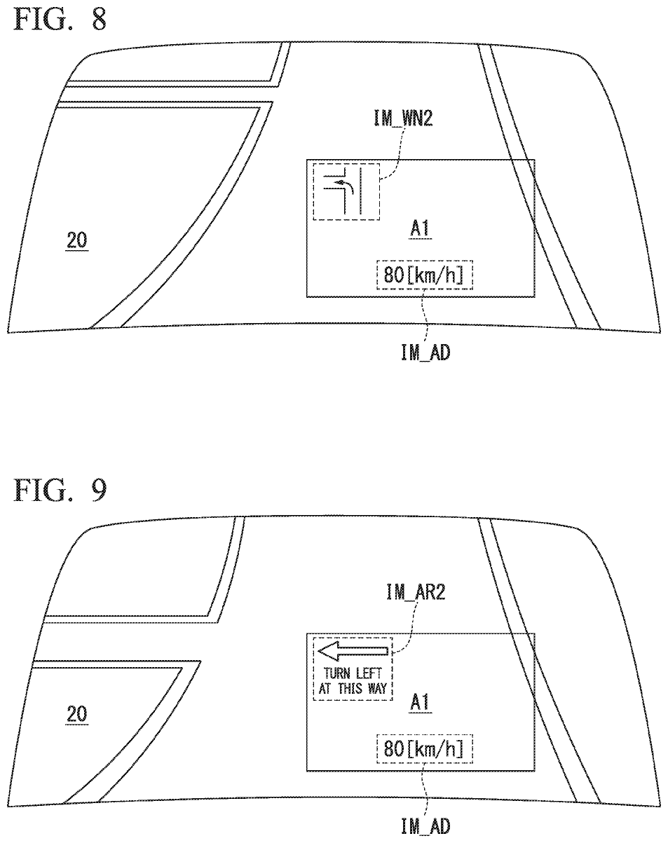

The target that is a target of the display is not limited to a target corresponding to a “protected object” or an “obstacle” such as a pedestrian, but may be a fixed target such as a left turn point. Information such as the left turn point is acquired from, for example, a navigation device (not shown) or the like. FIGS. 8 and 9 are diagrams respectively showing the presence notification image and the AR image for the fixed target.

In the example shown in FIG. 8, in front of the vehicle M, there is a point at which the vehicle M turns left according to a route generated by the navigation device. However, a road of a destination at which the vehicle M turns left is ahead of the displayable area A1, and it is difficult to directly indicate the road of the left turn destination. In this case, the presence notification image generator 157 generates, for example, a presence notification image IM_WN2 similar to a navigation image provided by the navigation device.

The example shown in FIG. 9 shows a situation in which time has passed from the situation of FIG. 8. At this time point, the road of the left turn destination reaches a side of the displayable area A1. In this case, the presence notification image generator 157 generates, for example, an AR image IM_AR2 in which an arrow is superimposed and shown on the road surface and in which information indicating that a left turn should be made is added. Therefore, it possible to intuitively convey the approach and the approach direction of the fixed target to the driver.

The process of the entry determiner 156 may be omitted, and the display device 100 may display the presence notification image for all targets or a target narrowed down by a method different from that of the entry determiner 156.

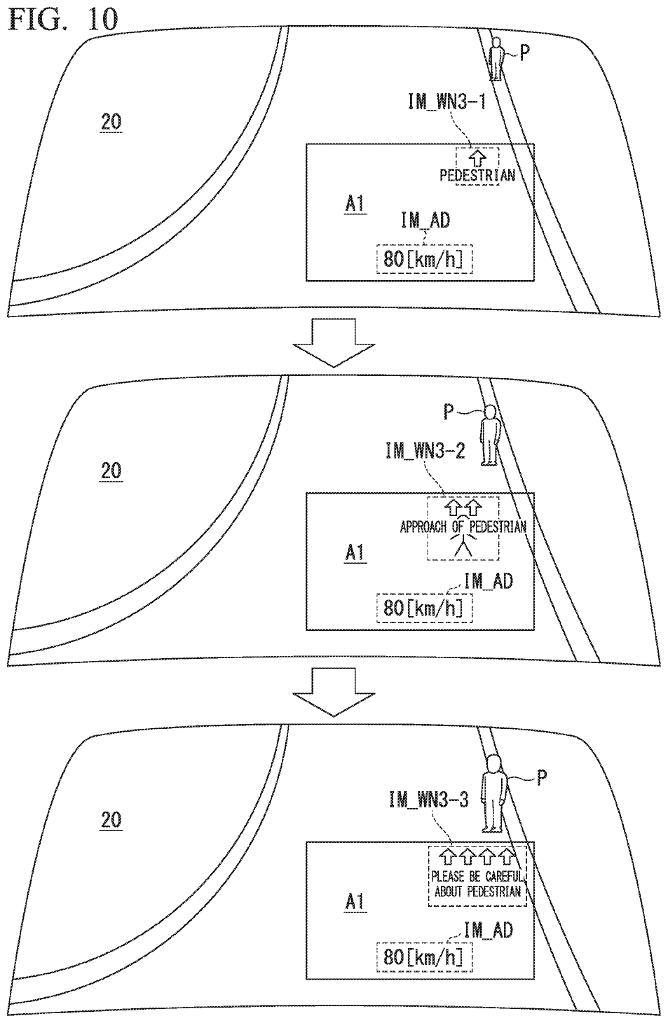

In a case in which the target enters the space area within the predetermined time, the presence notification image generator 157 may change a display mode of the presence notification image IM_WN in accordance with a time until the entry. The time to the entry is calculated on the basis of the relative velocity vector and the distance between the target and the road surface area RA1. FIG. 10 is a diagram showing an example of a change of the presence notification image. As shown in the figure, the presence notification image generator 157 may change the presence notification image IM_WN to an image with high conspicuousness, in accordance with the time until the entry is shortened. The more conspicuous image is, for example, an image in which a size of a display area or a display element (figure or character) is larger, color is close to primary color, or a meaningful expression conveys urgency. Therefore, the display device 100 is able to more intuitively transfer the approach of the target to the driver.

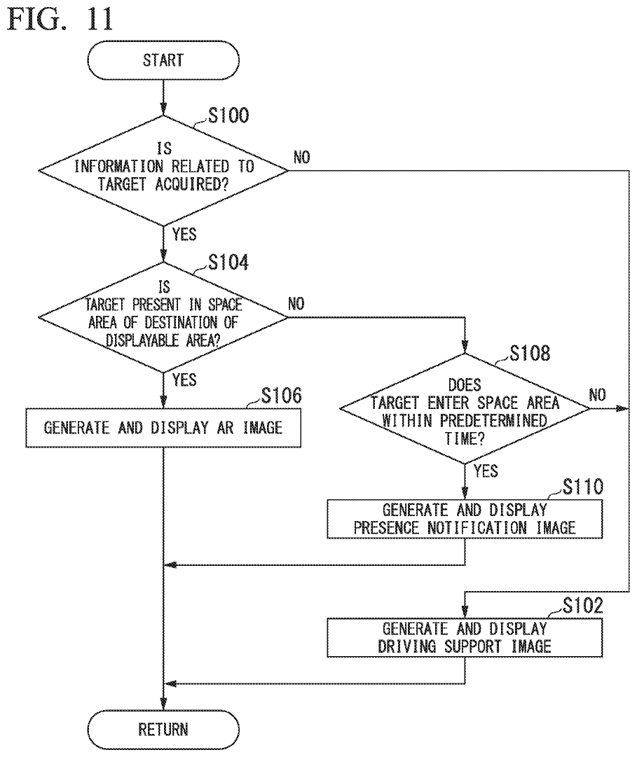

FIG. 11 is a flowchart showing an example of a flow of a process performed by the display controller 150. The display controller 150 determines whether or not the information related to the target is acquired from the target information acquirer 210 (step S100). In a case in which the information related to the target is not acquired, the driving support image generator 153 generates and displays the driving support image (step S102).

In a case in which the information related to the target is acquired, the area determiner 154 determines whether or not the target is in the space area of the destination passing through the displayable area A1 as viewed from the driver (step S104). In a case in which it is determined that the target is in the space area, the AR image generator 155 generates and displays the AR image related to the target (step S106). At this time, the driving support image may be displayed together with the AR image or may not be displayed.

In a case in which it is determined that the target is not in the space area, the entry determiner 156 determines whether or not the target enters the space area within the predetermined time (step S108). In a case in which it is determined that the target enters the space area within the predetermined time, the presence notification image generator 157 generates and displays the presence notification image (step S110). At this time, the driving support image may be displayed together with the presence notification image or may not be displayed. In a case in which it is determined that the target does not enter the space area within the predetermined time, the driving support image generator 153 generates and displays the driving support image (step S102).

According to the display device 100 of the embodiment described above, it is determined whether or not the target is in the space area of the destination passing through the displayable area A1 as viewed from the occupant (driver) of the vehicle, and in a case in which the target is in the space area, the AR image is displayed, and in a case in which the target is not in the space area, the presence notification image is displayed. Therefore, it is possible to suitably cover the world outside the area of the AR display.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A display device mounted on a vehicle, comprising:
an image generation device configured to project image light that is light including an image toward a projection area on a front windshield;
a target information acquirer configured to acquire at least a position of a target present around the vehicle; and
a controller configured to control the image generation device,
wherein the controller determines whether or not the target is in a space area of a destination passing through the projection area as viewed from an occupant of the vehicle,
in a case in which the target is in the space area of the destination passing through the projection area as viewed from the occupant of the vehicle, the controller causes the image generation device to project the image light that appears to be superimposed on the position of the target, and
in a case in which the target is not in the space area of the destination passing through the projection area as viewed from the occupant of the vehicle, the controller causes the image generation device to project the image light notifying of presence of the target in the projection area.

2. The display device according to claim 1,
wherein the controller determines whether or not the target enters the space area within a predetermined time or within a predetermined traveling distance on the basis of a relative position change between the vehicle and the target, and in a case in which it is determined that the target enters the space area within the predetermined time or within the predetermined traveling distance, the controller causes the image generation device to project the image light notifying of the presence of the target in the projection area.

3. The display device according to claim 1,
wherein the controller estimates a position where the target first appears in the projection area on the basis of a relative position change between the vehicle and the target, and controls the image generation device so that the image light notifying of the presence of the target is projected at the estimated position.

4. The display device according to claim 1,
wherein the controller controls the image generation device to change a display mode of the image light notifying of the presence of the target on the basis of a time until the target enters the space area, which is calculated on the basis of a relative positional change between the vehicle and the target.

5. The display device according to claim 1,
wherein the controller controls the image generation device to cause the image light notifying of the presence of the target a light to have a color close to an environmental color in comparison with the image light that appears to be superimposed on the position of the target.

6. The display device according to claim 1,
wherein the image generation device comprises:
a light projector configured to project the light including the image;
an optical mechanism provided on a path of the light and capable of adjusting a distance from a predetermined position to a position where the light is formed as a virtual image;
a concave mirror configured to reflect light passing through the optical mechanism toward a reflector;
a first actuator configured to adjust the distance in the optical mechanism; and
a second actuator configured to adjust a reflection angle of the concave mirror.

7. A display control method for a display device, which is mounted in a vehicle and comprises an image generation device configured to project image light that is light including an image toward a projection area on a front windshield and a target information acquirer configured to acquire at least a position of a target present around the vehicle, the method causing a controller of the display device to:
determine whether or not the target is in a space area of a destination passing through the projection area as viewed from an occupant of the vehicle;
cause the image generation device to project the image light that appears to be superimposed on the position of the target in a case in which the target is in the space area of the destination passing through the projection area as viewed from the occupant of the vehicle; and
cause the image generation device to project the image light notifying of presence of the target in the projection area in a case in which the target is not in the space area of the destination passing through the projection area as viewed from the occupant of the vehicle.

8. A non-transitory computer-readable storage medium that stores a program for a display device, which is mounted in a vehicle and comprises an image generation device configured to project image light that is light including an image toward a projection area on a front windshield and a target information acquirer configured to acquire at least a position of a target present around the vehicle, the program causing a controller of the display device to:
determine whether or not the target is in a space area of a destination passing through the projection area as viewed from an occupant of the vehicle;
cause the image generation device to project the image light that appears to be superimposed on the position of the target in a case in which the target is in the space area of the destination passing through the projection area as viewed from the occupant of the vehicle; and
cause the image generation device to project the image light notifying of presence of the target in the projection area in a case in which the target is not in the space area of the destination passing through the projection area as viewed from the occupant of the vehicle.
